(19) United States
(12) Patent Application Publication
(10) Pub. No.: US 2024/0037612 A1
(43) Pub. Date: Feb. 1, 2024

(54) SYSTEM AND METHOD FOR EVALUATING RIDE SERVICE FACILITATED BY AUTONOMOUS VEHICLE

(71) Applicant: GM Cruise Holdings LLC, San Francisco, CA (US)

(72) Inventors: Sarah M Rizk, San Francisco, CA (US); Oliver Cameron, San Jose, CA (US); Brendan Tomoschuk, Redwood City, CA (US); Alan Wells, San Rafaeil, CA (US)

(73) Assignee: GM Cruise Holdings LLC, San Francisco, CA (US)

(21) Appl. No.: 17/815,980

(22) Filed: Jul. 29, 2022

(51) Int. Cl. G06Q 30/02; G07C 5/08; G07C 5/00; G06V 40/16; G06V 20/59; G06V 20/56

(52) U.S. Cl. CPC G06Q 30/0282; G07C 5/0808; G07C 5/008; G06V 40/174; G06V 20/59; G06V 20/56

(57) ABSTRACT

A ride evaluation platform can evaluate ride services provided by AVs to users, e.g., to determine whether the users are satisfied with the rider services so that the users will request more ride services. The ride evaluation platform may identify and classify operational behaviors of an AV based on a record of the AV's operation for providing a ride service. The ride evaluation platforms can further detect defects in the ride service based on the classifications of operational behaviors of AVs, user expressions that indicate one or more user sentiments towards the ride service, one or more conditions of an environment in which the AV operated for providing the ride service, or some combination thereof. The ride evaluation platform may determine a score for the ride service based on the defects. The score may indicate a likelihood of the user would request another ride service provided by an AV.

### TECHNICAL FIELD OF THE DISCLOSURE

The present disclosure relates generally to autonomous vehicles (AVs) and, more specifically, to evaluating ride services facilitated by AVs.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs that can provide services to users;

FIG. 2 is a block diagram showing a fleet management system, according to some embodiments of the present disclosure;

FIG. 3 is a block diagram showing a ride evaluation module, according to some embodiments of the present disclosure;

FIG. 4 illustrates a machine learning system for ride evaluation, according to some embodiments of the present disclosure;

FIG. 5 is a block diagram showing a sensor suite, according to some embodiments of the present disclosure;

FIG. 6 is a block diagram showing an onboard computer, according to some embodiments of the present disclosure; and

FIG. 7 is a flowchart showing a method of evaluating a ride provided by a vehicle, according to some embodiments of the present disclosure.

### DESCRIPTION OF EXAMPLE EMBODIMENTS OF THE DISCLOSURE

Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

AVs can provide driverless ride services. A person can request an AV to pick him/her up from a location and drop him/her off at another location. With the autonomous driving features of the AV, the person does not have to drive during the ride and can be a passenger of the AV. The AV can navigate from the pick-up location to the drop-off location with no or little user input. To improve ride services provided by AVs, it is important to evaluate whether users are satisfied with rides provided AVs (“AV rides”) and to identify causes of user satisfaction and dissatisfaction. Currently available technology for evaluating ride services usually use limited metrics to evaluate user experiences. For example, the currently available technology highly relies on user feedback to evaluate ride services. As a result, the currently available technology lacks a full-scope evaluations of ride services and fails to capture the full extent of user experience issues with ride services. Therefore, improved technology for evaluating ride services is needed.

Embodiments of the present disclosure provides a ride evaluation platform that evaluates AV rides with a full-scope metric that includes monitorization of AV movements, analyzation of user feedback, and detection of scene context. The full-scope metric can unlock insights into user experiences of AV rides and facilitate diagnosis and improvement of defects in AV rides so that user satisfactoriness with AV rides can be enhanced.

AV movements can be monitored by capturing data indicating operational behaviors of AVs (“AV operational behaviors” or “AV behaviors”). For instance, an AV may generate a record of operation (“operation record”) associated with a ride service. The operation records may include information of AV behaviors associated with the ride service. AV behaviors associated with the ride service are operational behaviors of AV that can influence the quality of the ride service provided by the AV and may include AV behaviors before the ride, during the ride, after the ride, or some combination thereof. The ride evaluation platform may identify and classify the AV behaviors based on the operation record. AV behaviors may be classified as negative AV behaviors (i.e., AV behaviors that degrade the quality of the ride service), positive AV behaviors (i.e., AV behaviors that enhance the quality of the ride service), neutral AV behaviors (i.e., AV behaviors that do not degrade or enhance the quality of the ride service).

The ride evaluation platform may detect user-specific defects or merits in the ride service based on the classification of identified AV behaviors, user sentiments towards the AV behaviors, scene context of the AV behaviors, or some combination thereof. Defects in ride services can create user distrust of AV rides, versus merits in ride services can promote user retention. User expressions can include statements, actions, emotional expressions, or other types of expressions of the user. The ride evaluation platform may determine a user sentiment towards a particular AV behavior. The ride evaluation platform may also detect an environmental condition associated with the AV behavior, i.e., a condition in an environment where the AV performs the AV behavior. The ride evaluation platform can determine a score for the ride service (“ride score”) based on the defects, the merits, or both. The ride score indicates user satisfaction for AV ride (e.g., the extent how the user satisfies with the ride service) and can also indicate user retention for AV ride (e.g., a likelihood that the user would request ride services in the future). The ride evaluation platform can evaluate historical ride services (e.g., a ride service that has been completed), current ride services (e.g., a ride service currently being performed by an AV), and future ride services (e.g., a ride service that has been requested but not started). The ride evaluation platform can also generate instructions for AVs to correct defects or promote merits to enhance user satisfaction with ride services.

The ride evaluation platform is more advantageous than conventional ride evaluation systems. With the full-scope metric, the ride evaluation platform in the present invention can identify user-specific defects or merits in ride services provided by AVs, target at issues that users have with ride services, and enhance user satisfaction with AV rides. Compared with conventional ride evaluation systems, the ride evaluation platform in the present invention provides is more effective to minimize user distrust of AV rides and to promote user retention. The ride evaluation platform can also enable advancement in AV technologies by learning from user experiences.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

Example System Facilitating Ride Evaluation Platform

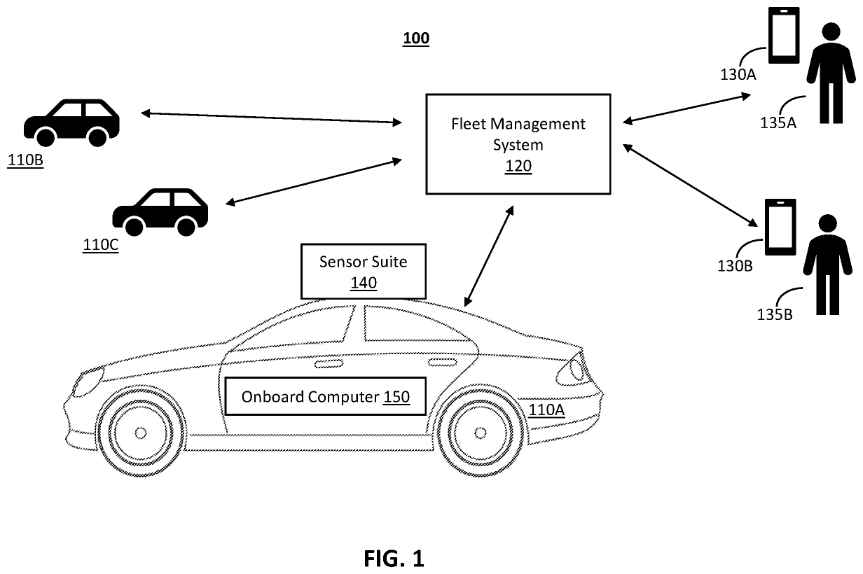

FIG. 1 illustrates a system 100 including a fleet of AVs that can provide services to users, according to some embodiments of the present disclosure. The system 100 includes AVs 110A-110C (collectively referred to as “AVs 110” or “AV 110”), a fleet management system 120, and client devices 130A and 130B (collectively referred to as “client devices 130” or “client device 130”). The client devices 130A and 130B are associated with users 135A and 1356, respectively. The AV 110A includes a sensor suite 140 and an onboard computer 150. Even though not shown in FIG. 1, the AV 110B or 110C can also include a sensor suite 140 and an onboard computer 150. In other embodiments, the system 100 may include more, fewer, or different components. For example, the fleet of AVs 110 may include a different number of AVs 110 or a different number of client devices 130.

The fleet management system 120 manages the fleet of AVs 110. The fleet management system 120 may manage one or more services that the fleet of AVs 110 provides to the users 135. An example service is a ride service, e.g., an AV 110 provides a ride to a user 135 from a first location to a second location. Another example service is a delivery service, e.g., an AV 110 delivers one or more items from or to the user 135. The fleet management system 120 can select one or more AVs 110 (e.g., AV 110A) to perform a particular service, and instructs the selected AV to drive to one or more particular locations associated with the service (e.g., a first address to pick up user 135A, and a second address to pick up user 135B). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a network, such as the Internet.

In some embodiments, the fleet management system 120 receives service requests for the AVs 110 from the client devices 130. In an example, the user 135A accesses an app executing on the client device 130A and requests a ride from a pickup location (e.g., the current location of the client device 130A) to a destination location. The client device 130A transmits the ride request to the fleet management system 120. The fleet management system 120 selects an AV 110 from the fleet of AVs 110 and dispatches the selected AV 110A to the pickup location to carry out the ride request. In some embodiments, the ride request further includes a number of passengers in the group. In some embodiments, the ride request indicates whether a user 135 is interested in a shared ride with another user traveling in the same direction or along a same portion of a route. The ride request, or settings previously entered by the user 135, may further indicate whether the user 135 is interested in interaction with another passenger.

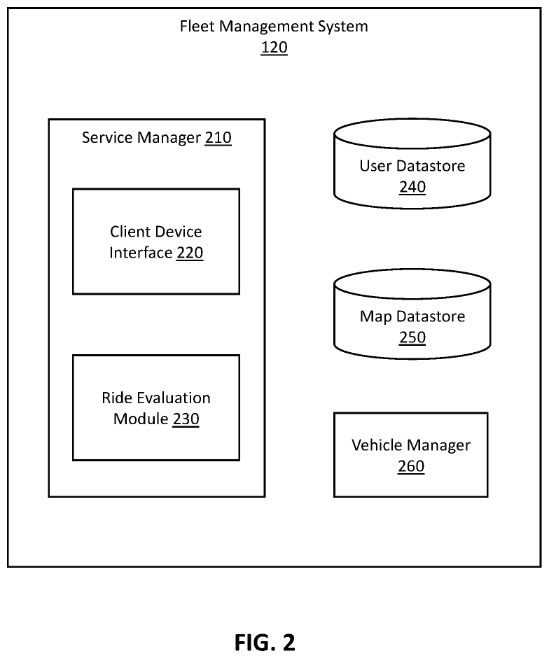

The fleet management system 120 also facilitates a ride evaluation platform that evaluates ride services provided by the AVs 110 to the users 135. The ride evaluation platform can rate quality of past, current, and future rides provided by AVs 110 based on a full-scope metric that covers operational behaviors of the AVs 110, expressions of users 135 receiving the rides, and conditions of environments where the rides are provided. An environment may be a real-world scene that an AV 110 operates to provide a ride to a user 135. Example environments include a street, a community, a city, and so on. In addition to rating rides provided by AVs 110, the ride evaluation platform can also facilitate improvement in ride quality to improve user trust and retention for AV rides. More details regarding the ride evaluation platform are provided below in conjunction with FIGS. 2-4.

A client device 130 is a device capable of communicating with the fleet management system 120, e.g., via one or more networks. The client device 130 can transmit data to the fleet management system 120 and receive data from the fleet management system 120. The client device 130 can also receive user input and provide outputs. In some embodiments, outputs of the client devices 130 are in human-perceptible forms, such as text, graphics, audio, video, and so on. The client device 130 may include various output components, such as monitors, speakers, headphones, projectors, and so on. The client device 130 may be a desktop or a laptop computer, a smartphone, a mobile telephone, a personal digital assistant (PDA), or another suitable device.

In some embodiments, a client device 130 executes an application allowing a user 135 of the client device 130 to interact with the fleet management system 120. For example, a client device 130 executes a browser application to enable interaction between the client device 130 and the fleet management system 120 via a network. In another embodiment, a client device 130 interacts with the fleet management system 120 through an application programming interface (API) running on a native operating system of the client device 130, such as IOS® or ANDROID™. The application may be provided and maintained by the fleet management system 120. The fleet management system 120 may also update the application and provide the update to the client device 130.

In some embodiments, a user 135 may submit service requests to the fleet management system 120 through a client device 130. A client device 130 may provide its user 135 a user interface (UI), through which the user 135 can make service requests, such as ride request (e.g., a request to pick up a person from a pickup location and drop off the person at a destination location), delivery request (e.g., a request to delivery one or more items from a location to another location), and so on. The UI may allow users 135 to provide locations (e.g., pickup location, destination location, etc.) or other information that would be needed by AVs 110 to provide services requested by the users 135. The client device 130 may also provide the user 135 an UI through which the user 135 can interact with the ride evaluation platform. For instance, the UI enables the user to submit a request for assistance to the ride evaluation platform through a network or a telephone service (e.g., a customer service hotline). The UI can further facilitate a communication between the user 135 and an agent of the ride evaluation platform who can provide the requested assistance. The UI may further enable the user to rate the agent or the ride evaluation platform.

The AV 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

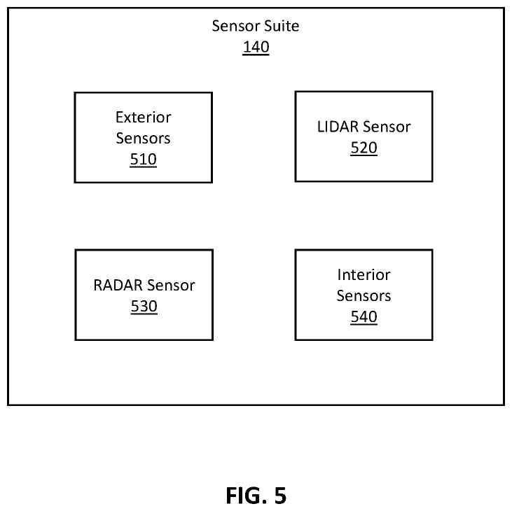

The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 5.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls behavior of the AV 110. The onboard computer 150 may be preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

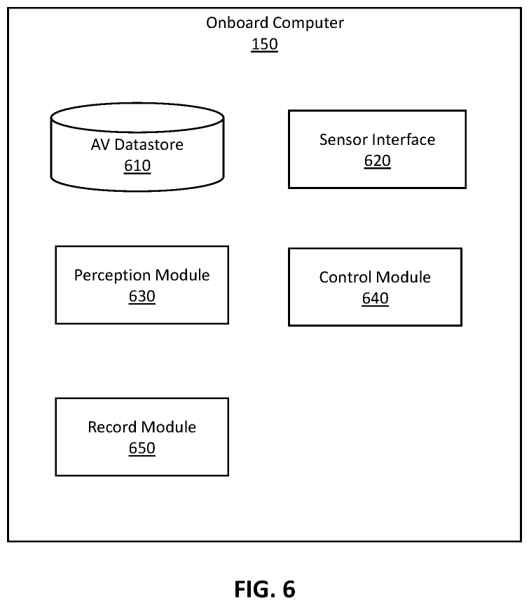

In some embodiments, the onboard computer 150 is in communication with the fleet management system 120, e.g., through a network. The onboard computer 150 may receive instructions from the fleet management system 120 and control behavior of the AV 110 based on the instructions. For example, the onboard computer 150 may receive from the fleet management system 120 an instruction for providing a ride to a user 135. The instruction may include information of the ride (e.g., pickup location, drop-off location, intermediate stops, etc.), information of the user 135 (e.g., identifying information of the user 135, contact information of the user 135, etc.). The onboard computer 150 may determine a navigation route of the AV 110 based on the instruction. As another example, the onboard computer 150 may receive from the fleet management system 120 a request for sensor data to be used by the ride evaluation platform. The onboard computer 150 may control one or more sensors of the sensor suite 140 to detect the user 135, the AV 110, or an environment surrounding the AV 110 based on the instruction and further provide the sensor data from the sensor suite 140 to the fleet management system 120. The onboard computer 150 may transmit other information requested by the fleet management system 120, such as perception of the AV 110 that is determined by a perception module of the onboard computer 150, historical data of the AV 110, and so on. Certain aspects of the onboard computer 150 are described further in relation to FIG. 6.

Example Fleet Management System

FIG. 2 is a block diagram showing the fleet management system, according to some embodiments of the present disclosure. The fleet management system 120 includes a service manager 210, a user datastore 240, a map datastore 250, and a vehicle manager 260. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 150.

The service manager 210 manages services that the fleet of AVs 110 can provide. The service manager 210 includes a client device interface 220 and a ride evaluation module 230. The client device interface 220 provides interfaces to client devices, such as headsets, smartphones, tablets, computers, and so on. For example, the client device interface 220 may provide one or more apps or browser-based interfaces that can be accessed by users, such as the users 135, using client devices, such as the client devices 130. The client device interface 220 enables the users to submit requests to a ride service provided or enabled by the fleet management system 120. In particular, the client device interface 220 enables a user to submit a ride request that includes an origin (or pickup) location and a destination (or drop-off) location. The ride request may include additional information, such as a number of passengers traveling with the user, and whether or not the user is interested in shared ride with one or more other passengers not known to the user.

The client device interface 220 can also enable users 135 to request animated route previews. The client device interface 220 can provide one or more options for a user 135 to submit a request for a route preview animation through a client device 130 associated with the user 135. In some embodiments, the client device interface 220 allows the user 135 to provide one or more parameters for a navigation route that the user 135 wants to preview. Example parameters include location parameter, time parameter, travel medium parameter, distance parameter, entertainment parameter, and so on. A location parameter may include one or more locations, such as location of a starting point, location of an intermediate stop along the navigation route, location of a final stop of the navigation route, and so on. A time parameter may include a time window for the navigation, a particular date or time that the navigation starts or ends, etc. A travel medium parameter may indicate one or more types of travel medium, such as AVs 110, other vehicles, buses, planes, bikes, walking, running, and so on. A distance parameter may include a preference for a shorter or longer navigation distance, a maximum distance, a minimum distance, and so on. An entertainment parameter may indicate the user's preference for views along the navigation route (e.g., natural scenes, street views, landmarks, or other views that the user prefers to have or prefers to avoid), preference for activities that can be performed or avoided along the navigation route (e.g., options for entertainment activities, options for food or drinks, options for shopping, etc.), and so on.

The client device interface 220 can also facilitate presentation of route preview animations to users 135. For instance, the client device interface 220 may support and maintain user interfaces running on client devices 130, such as the user interfaces described above in conjunction with the client devices 130 in FIG. 1. The client device interface 220 can further facilitate interactions of users 135 with route preview animations.

The ride evaluation module 230 facilitates a ride evaluation platform, e.g., the ride evaluation platform described above. The ride evaluation module 230 can evaluate a ride provided by an AVs 110 to one or more users 135 based on operational behaviors of the AV 110, expressions of the one or more users 135, and scene context associated with the ride. The ride evaluation platform can identify negative or positive AV behaviors associated with the ride. A negative AV behavior may negatively influence the quality of the ride, such as an AV behavior that can impact operational safety of the AV 110, cause discomfort to a user 135, or both. In contrast, a positive AV behavior may enhance the quality of the ride service, such as an AV behavior that can contribute to safe operation of the AV 110, comfort of a user 135, or both.

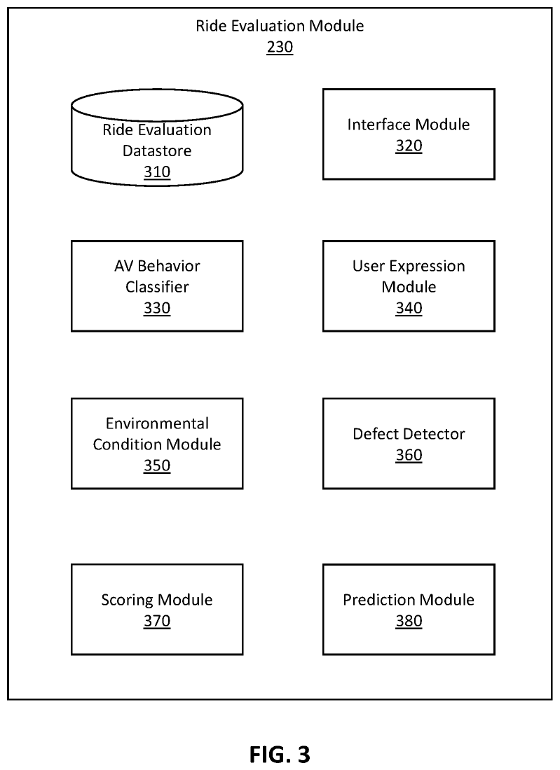

In some embodiments, the ride evaluation module 230 can determine a category of an AV behavior and further determine whether the AV behavior is a defect or merit based on whether the category is a category of negative AV behavior, one or more user sentiments towards the AV behavior, and one or more conditions of an environment where the AV performs the AV behavior. The ride evaluation module 230 can rate the quality of ride based on defects or merits in the ride. The ride evaluation module 230 can further improve the quality of the ride, e.g., by instructing the AV 110 to correct a defect or promote a merit. Certain aspects of the ride evaluation module 230 are described below in conjunction with FIG. 3.

The user datastore 240 stores information associated with users 135. The user datastore 240 stores information associated with rides requested or taken by the user 135. For instance, the user datastore 240 may store information of a ride currently being taken by a user 135, such as an origin location and a destination location for the user's current ride. The user datastore 240 may also store historical ride data for a user 135, including origin and destination locations, dates, and times of previous rides taken by a user. The user datastore 240 may also store expressions of the user 135 that are associated with a current ride or historical ride. In some cases, the user datastore 240 may further store future ride data, e.g., origin and destination locations, dates, and times of planned rides that a user has scheduled with the ride service provided by the AVs 110 and fleet management system 120. Some or all of the information of a user 135 in the user datastore 240 may be received through the client device interface 220, an onboard computer (e.g., the onboard computer 150), a sensor suite of AVs 110 (e.g., the sensor suite 140), a third-party system associated with the user and the fleet management system 120, or other systems or devices.

In some embodiments, the user datastore 240 stores data indicating user sentiments towards AV behaviors associated with ride services, such as information indicating whether a user feels comfortable or secured with an AV behavior. The fleet management system 120 may include one or more learning modules (not shown in FIG. 2) to learn user sentiments based on user data associated with AV rides, such as user expressions related to AV rides. The user datastore 240 may also store data indicating user interests associated with rides provided by AVs 110. The fleet management system 120 may include one or more learning modules (not shown in FIG. 2) to learn user interests based on user data. For example, a learning module may compare locations in the user datastore 240 with map datastore 250 to identify places the user has visited or plans to visit. For example, the learning module may compare an origin or destination address for a user in the user datastore 240 to an entry in the map datastore 250 that describes a building at that address. The map datastore 250 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user datastore 240.

In some embodiments, a user 135 is associated with a user profile stored in the user datastore 240. A user profile may include declarative information about the user 135 that was explicitly shared by the user 135 and may also include profile information inferred by the fleet management system 120. In one embodiment, the user profile includes multiple data fields, each describing one or more attributes of the user 135. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, an image of a user 135 may be tagged with information identifying the user 135 displayed in the image.

The map datastore 250 stores a detailed map of environments through which the AVs 110 may travel. The map datastore 250 includes data describing roadways, such as e.g., locations of roadways, connections between roadways, roadway names, speed limits, traffic flow regulations, toll information, etc. The map datastore 250 may further include data describing buildings (e.g., locations of buildings, building geometry, building types), and data describing other objects (e.g., location, geometry, object type) that may be in the environments of AV 110. The map datastore 250 may also include data describing other features, such as bike lanes, sidewalks, crosswalks, traffic lights, parking lots, signs, billboards, etc.

Some of the map datastore 250 may be gathered by the fleet of AVs 110. For example, images obtained by the exterior sensors 510 of the AVs 110 may be used to learn information about the AVs' environments. As one example, AVs may capture images in a residential neighborhood during a Christmas season, and the images may be processed to identify which homes have Christmas decorations. The images may be processed to identify particular features in the environment. For the Christmas decoration example, such features may include light color, light design (e.g., lights on trees, roof icicles, etc.), types of blow-up figures, etc. The fleet management system 120 and/or AVs 110 may have one or more image processing modules to identify features in the captured images or other sensor data. This feature data may be stored in the map datastore 250. In some embodiments, certain feature data (e.g., seasonal data, such as Christmas decorations, or other features that are expected to be temporary) may expire after a certain period of time. In some embodiments, data captured by a second AV 110 may indicate that a previously-observed feature is no longer present (e.g., a blow-up Santa has been removed) and in response, the fleet management system 120 may remove this feature from the map datastore 250.

The vehicle manager 260 manages and communicates with the fleet of AVs 110. The vehicle manager 260 assigns the AVs 110 to various tasks and directs the movements of the AVs 110 in the fleet. The vehicle manager 260 includes a vehicle manager 260 and an AV 110 interface 290. In some embodiments, the vehicle manager 260 includes additional functionalities not specifically shown in FIG. 2. For example, the vehicle manager 260 instructs AVs 110 to drive to other locations while not servicing a user, e.g., to improve geographic distribution of the fleet, to anticipate demand at particular locations, etc. The vehicle manager 260 may also instruct AVs 110 to return to an AV 110 facility for fueling, inspection, maintenance, or storage.

In some embodiments, the vehicle manager 260 selects AVs from the fleet to perform various tasks and instructs the AVs to perform the tasks. For example, the vehicle manager 260 receives a ride request from the client device interface 220. The vehicle manager 260 selects an AV 110 to service the ride request based on the information provided in the ride request, e.g., the origin and destination locations. If multiple AVs 110 in the AV 110 fleet are suitable for servicing the ride request, the vehicle manager 260 may match users for shared rides based on an expected compatibility. For example, the vehicle manager 260 may match users with similar user interests, e.g., as indicated by the user datastore 240. In some embodiments, the vehicle manager 260 may match users for shared rides based on previously-observed compatibility or incompatibility when the users had previously shared a ride.

The vehicle manager 260 or another system may maintain or access data describing each of the AVs in the fleet of AVs 110, including current location, service status (e.g., whether the AV 110 is available or performing a service; when the AV 110 is expected to become available; whether the AV 110 is schedule for future service), fuel or battery level, etc. The vehicle manager 260 may select AVs for service in a manner that optimizes one or more additional factors, including fleet distribution, fleet utilization, and energy consumption. The vehicle manager 260 may interface with one or more predictive algorithms that project future service requests and/or vehicle use, and select vehicles for services based on the projections.

The vehicle manager 260 transmits instructions dispatching the selected AVs. In particular, the vehicle manager 260 instructs a selected AV 110 to drive autonomously to a pickup location in the ride request and to pick up the user and, in some cases, to drive autonomously to a second pickup location in a second ride request to pick up a second user. The first and second user may jointly participate in a virtual activity, e.g., a cooperative game or a conversation. The vehicle manager 260 may dispatch the same AV 110 to pick up additional users at their pickup locations, e.g., the AV 110 may simultaneously provide rides to three, four, or more users. The vehicle manager 260 further instructs the AV 110 to drive autonomously to the respective destination locations of the users.

FIG. 3 is a block diagram showing the ride evaluation module 230, according to some embodiments of the present disclosure. As described above, the ride evaluation module 230 can rate trips (e.g., rides) provided to users 135 by AVs 110. The ride evaluation module 230 includes a ride evaluation datastore 310, an interface module 320, an AV behavior classifier 330, a user expression module 340, an environmental condition module 350, a defect detector 360, a scoring module 370, and a prediction module 380. In alternative configurations, different and/or additional components may be included in the ride evaluation module 230. Further, functionality attributed to one component of the ride evaluation module 230 may be accomplished by a different component included in the ride evaluation module 230, a different component included in the fleet management system 120, or a different system than those illustrated, such as the onboard computer 150.

The ride evaluation datastore 310 stores data received, generated, and used by the ride evaluation module 230. For example, the ride evaluation datastore 310 stores data received by the interface module 320. As another example, the ride evaluation datastore 310 stores data generated by the AV behavior classifier 330, user expression module 340, environmental condition module 350, defect detector 360, scoring module 370, and prediction module 380.

The interface module 320 facilitates communications of the ride evaluation module 230 with other components of the fleet management system 120, other systems, or devices. In some embodiments, the interface module 320 receives data from the client device interface 220. The interface module 320 can also retrieve data from datastores in the fleet management system 120, such as the user datastore 240 and the map datastore 250. The interface module 320 may also communicate with AVs 110, e.g., onboard computers of AVs, to receive data from the AVs 110, send instructions to the AVs 110, and so on. For example, the interface module 320 can receive AV operation records, AV sensor data, AV perceptions, or other data from onboard computers. As another example, the interface module 320 may send instructions from another component of the ride evaluation module 230 to onboard computers of AVs 110, such as instruction to capture sensor data, instruction for navigation, instruction for localization, and so on. In some embodiments, the interface module 320 may communicate with client devices, e.g., the client devices 130. The interface module 320 can receive or request inputs from the users 135 through the communication with the client devices 130.

The interface module 320 communicates with other components of the ride evaluation module 230. The interface module 320 may provide received data to the other components of the ride evaluation module 230. For example, the interface module 320 may provide received AV data to the AV behavior classifier 330 for the AV behavior classifier 330 to identify and classify AV operational behaviors. As another example interface module 320 may provide received user data to the user expression module 340 for the user expression module 340 to identify user expressions. The interface module 320 can also send data to the ride evaluation datastore 310 where the data will be stored.

The AV behavior classifier 330 identifies and classifies AV behaviors in association with ride services provided by AVs 110. AV behaviors associated with a ride service are operational behaviors of the AV 110 that can influence the quality of the ride service provided by the AV 110, such as AV behaviors that can cause negative sentiment of users 135 towards the ride services. AV behaviors that can influence the quality of the ride service may include AV behaviors before the ride, during the ride, after the ride, or some combination thereof. Example AV behaviors include detection (e.g., detections by sensors), perception (identification of objects detected by sensors), prediction, localization, planning, navigation, interaction with passengers, interaction with other objects (e.g., non-passenger people, other vehicles, traffic signs, etc.), and so on. In some embodiments, the AV behavior classifier 330 identifies AV behaviors associated with a ride service from an operation record of the AV 110 providing the ride service. The operation record may be provided by an onboard computer 150 of the AV 110 and include information of operations of the AV 110 for providing the ride service. The AV behavior classifier 330 may also use other data (such as data from the vehicle manager 260) that can indicate operations of the AV 110 for providing the ride service to identity the AV behaviors.

The AV behavior classifier 330 classifies identified AV behaviors into categories. Example categories include pre-ride behaviors, on-ride behaviors, post-ride behaviors, pick-up behaviors, drop-off behaviors, navigation behaviors, intersection maneuver behaviors, late pick-ups, improper pick-up and drop-off locations, unexpected stops, abrupt change, unexpected change of speed, harsh braking, risky interactions, other aggressive behaviors, and so on. The AV behavior classifier 330 may classify an identified AV behavior into more than one category. The categories may include predetermined categories, e.g., categories predetermined as desirable behavior categories, undesirable behavior categories, or neutral behavior categories. A desirable behavior category may be a category of AV behaviors that are objectively desirable, e.g., AV behaviors that can typically enhance AV safety or passenger comfort. An undesirable behavior category may be a category of AV behaviors that are objectively undesirable, e.g., AV behaviors that can typically undermine AV safety or passenger comfort. An undesirable AV behavior may be assumed as a defect in the ride service without knowing user sentiment towards the AV behavior or context in the scene where the AV behavior is performed. A neutral behavior category may be a category of AV behaviors that are objectively neutral, e.g., AV behaviors that typically have no influence on AV safety or passenger comfort. The AV behavior classifier 330 may select one or more categories of an AV behavior from predetermined categories.

The AV behavior classifier 330 may determine a category for an AV behavior based on a timestamp associated with the AV behavior. For instance, the AV behavior classifier 330 classifiers AV behaviors associated with timestamps before a ride started (before the AV 110 started driving from the starting point of the ride) to the pre-ride category. Similarly, AV behaviors associated with timestamps during the ride are classified into the on-ride category, and AV behaviors associated with timestamps after the ride (after the AV 110 arrived at the destination of the ride) are classified into the post-ride category. Alternatively or additionally, the AV behavior classifier 330 may determine a category for an AV behavior based on a location associated with the AV behavior. For instance, the AV behavior classifier 330 classifies AV behaviors at a location matching the pick-up location as pick-up behaviors. Similarly, AV behaviors at a location matching the drop-off location are classified as drop-off behaviors, and AV behaviors at a location between the pick-up location and the drop-off location may be classified as on-rid behaviors. A location of an AV behavior may be a location of the AV 110 at the time the AV 110 performed the AV behavior. The location may be determined by one or more sensors of the AV 110. Timestamps and locations of AV behaviors can be included in the operation record of the AV 110.

In some embodiments, the AV behavior classifier 330 may determine whether the identified AV behavior falls into a category based on a reference AV behavior for the category. The reference AV behavior may be an expected AV behavior (e.g., a behavior instructed by the vehicle manager 260), a standard AV behavior (e.g., a behavior that AVs 110 would normally perform in same or similar situations), a safety-driven AV behavior (e.g., a behavior that AVs 110 should take or avoid for safety reasons), a comfort-driver AV behavior (e.g., a behavior that AVs 110 should take or avoid for comfort of passengers), and so on. The AV behavior classifier 330 may place the AV behavior into the category in response to a determination that the AV behavior does not match the reference behavior. The AV behavior classifier 330 may determine that the AV behavior does not match the reference behavior based on that the behavior is different from the reference behavior, a parameter of the AV behavior is different from a corresponding parameter of the reference AV behavior, or a difference between the parameter and the corresponding parameter is beyond a threshold. Example parameters may be speed, direction, position/location, distance, time, acceleration rate, deacceleration rate, setting of an AV component, and so on.

In an example, the AV behavior classifier 330 identifies a brake done by an AV 110 by identifying a deacceleration in the operations record of the AV 110. The AV behavior classifier 330 further determines whether the brake is too hard based on a rate at which whether the AV 110 deaccelerated and compares the deacceleration rate with a reference decertation rate. In response to a determination that the deacceleration rate is higher than the reference decertation rate, the AV behavior classifier 330 classifies the brake of the AV 110 into the harsh braking category, which is an undesirable behavior category.

In some embodiments, the AV behavior classifier 330 may classifies AV behaviors associated with a ride service based on a user profile of a user 135 receiving the ride service or a user profile of another user 135 deemed similar to the user 135 receiving the ride service. The user profile may include information indicating the user's sentiment towards various AV behaviors. The classification of AV behaviors is personalized, and the classification of a same AV behavior for different users 135 can be difference. For instance, a braking may be undesirable to a user 135 but neutral for another user 135.

The user expression module 340 identifies user expressions associated with rides of users 135 in AVs 110. User expressions associated with a ride are expressions of a user 135 that indicate a sentiment (positive or negative) of the user 135 towards the ride service, a part of the ride service, or a particular AV behavior associated with the ride service. User expressions may include statements made by the user 135 in association with the ride service, such as a statement provided by the user 135 to the fleet management system 120 (e.g., a rating on the ride service, feedback to a questionnaire from the fleet management system 120, etc.), a statement made by the user 135 to an agent of the fleet management system 120, a statement provided by the user 135 to a third-party system (e.g., a social media system, etc.), a statement provided by the user 135 to another person (e.g., a friend, family member, another user 135 who shares the ride with the user 135, etc.), and so on.

User expressions may also include actions of the user 135 in association with the ride service, including user actions before, during, or after the ride service. Example user actions include walking, running, gestures, and so on. User expressions may also include emotional expressions made by the user 135 in association with the ride service. Example emotional expression include facial expressions, sound made by the user 135, and so on. User expressions may be provided by the user 135, e.g., through a client device 130, the onboard computer 150, the client device interface 220, or a third-party system. User expressions may also be captured by sensors of the AV 110. For instance, sensors of the AV 110 may capture the user's facial expressions, sound, actions, and so on.

In some embodiments, the user expression module 340 can determine one or more sentiments of the user 135 towards the ride service based on user expressions. The user expression module 340 may determine user sentiments by using various technologies, such as natural language processing, facial emotion analysis, and so on. The user expression module 340 can infer user sentiments from user actions. For instance, the user expression module 340 may determine that the user 135 is not satisfied based on a detection that the user 135 got off the AV 110 from a door on the street side, as opposed to a door on the sideway side. The user expression module 340 may determine a sentiment of the user 135 towards the whole ride. For example, the user expression module 340 may determine a satisfaction score that indicates the level of satisfaction of the user 135 for the ride. As another example, the ride evaluation platform may generate a label (such as “very satisfied,” “satisfied,” “neutral,” “unsatisfied,” “frustrated,” etc.) that indicates the level of satisfaction of the user 135 for the ride.

Alternatively or additionally, the user expression module 340 can apply user expressions to determine a sentiment of the user 135 towards a portion of the ride or a particular AV behavior associated with the ride. In some embodiments, the user expression module 340 may identify one or more user expressions related to the AV behavior, such as user expressions at the time or location (or near the time or location) of the AV behavior, user expressions in which the AV behavior is mentioned, and so on. The user expression module 340 further uses the identified user expressions to determine the user's sentiment towards the AV behavior. For instance, the user expression module 340 may determine that the user 135 was cheerful, happy, comfortable, relaxed, sad, angry, frustrated, scared, etc. at the time (or shortly after the time) of an AV behavior and may also determine that the user sentiment was caused at least partially by the AV behavior.

The user expression module 340 may receive a request from the AV behavior classifier 330 to determine a user sentiment towards an AV behavior. The request may include information of the AV behavior, such as category, description, time, location, and so on. The user expression module 340 can use the information in the request to identify user expressions related to the AV behavior. For instance, the user expression module 340 can identify user statements that mention the AV behavior, user actions at or near the time or location of the AV behavior, or user emotional expressions at or near the time or location of the AV behavior. The user expression module 340 then determine the user sentiment based on the identified user expressions.

In some embodiments, the user expression module 340 may, based on a determined user sentiment, request the AV behavior classifier 330 to identify and classify one or more AV behaviors related to the user sentiment. The request may include information of the user sentiment, e.g., description pf the user sentiment, information of user expressions used to determine the user sentiment, time, location, and so on. For example, after the user expression module 340 detects that the user 135 complained about an AV behavior (e.g., unexpected stop, late pick-up, etc.) in a statement made by the user 135 and determines that the user 135 has a negative sentiment towards the AV behavior, the user expression module 340 instructs the AV behavior classifier 330 to analyze the AV behavior. As another example, after the user expression module 340 detects that the user 135 has positive feedback on an AV behavior (e.g., unexpected stop, late pick-up, etc.) and determines that the user 135 has a positive sentiment towards the AV behavior, the user expression module 340 instructs the AV behavior classifier 330 to analyze the AV behavior. A determination of the user expression module 340 may conflict with a corresponding determination of the AV behavior classifier 330. For instance, the user expression module 340 detects a positive sentiment of the user 135 towards an AV behavior, despite that the AV behavior is classified into an undesirable behavior category by the AV behavior classifier 330. Similarly, the user expression module 340 detects a negative sentiment of the user 135 towards an AV behavior, despite that the AV behavior is classified into a desirable behavior category by the AV behavior classifier 330.

The environmental condition module 350 detects environmental conditions in association with rides provided by AVs 110. An environmental condition associated with a ride is a condition in an environment surrounding the AV 110 providing the ride or in an environment surrounding the user 135 having the ride. The condition may be a condition of an object (e.g., person, vehicle, traffic sign, building, tree, etc.) in the environment, a weather condition (e.g., rain, snow, ice, etc.), a traffic condition (e.g., traffic jam, road closure, etc.), or other types of environmental conditions. In some embodiments, the environmental condition module 350 detects one or more environmental conditions for a particular AV behavior associate with the ride. The one or more environmental conditions may indicate a cause or consequence of the particular AV behavior.

The environmental condition module 350 may detect an environmental condition based on data (e.g., sensor data, perceptions, etc.) from one or more AVs 110, such as the AV 110 providing the ride service in the environment, the same AV 110 operating in the environment at a different time, or another AV operating in the environment. The environmental condition module 350 may request such data from AVs 110. The environmental condition module 350 may search for one or more AVs 110 that operate in the environment at or near a time of interest (e.g., the time of an AV behavior) and after finding these AVs 110, the environmental condition module 350 can request data from these AVs 110. In some embodiments (e.g., embodiments where the environmental condition module 350 cannot find any AV 110 operating in the environment but for the AV 110 providing the service), the environmental condition module 350 may request the vehicle manager 260 to send an AV 110 to the environment and capture data needed by the environmental condition module 350. The environmental condition module 350 may provide an instruction to the AV 110. The instruction may include information of the environment (e.g., location), information of objects that need to be detected, specification of sensors to be used, setting of sensors, and so on.

The environmental condition module 350 may also use other data to detect environmental conditions. For instance, the environmental condition module 350 may retrieve data from a third-party system that publishes information related to environmental conditions. The third-party system may be a third-party reporting traffic conditions, a third-party predicting weather conditions, a social-medial system, and so on.

In some embodiments, the environmental condition module 350 receives a request from the AV behavior classifier 330 to detect one or more environmental conditions related to an AV behavior. The request may include information of the AV behavior, such as category, description, time, location, and so on. The environmental condition module 350 can use the information in the request to obtain related data, e.g., AV sensor data captured or AV perceptions made at or near a time or location of the AV behavior. The environmental condition module 350 then determine the environmental conditions based on the related data.

Also, the environmental condition module 350 may, based on a determined environmental condition, request the AV behavior classifier 330 to identify and classify one or more AV behaviors related to the user sentiment. The request may include information of the environmental condition, e.g., description, time, location, and so on. For example, after the environmental condition detects a car accident along the route of the ride, the environmental condition module 350 instructs the AV behavior classifier 330 to analyze one or more AV behaviors at or near a time or location of the car accident.

The defect detector 360 detects defects in ride services. A defect in a ride service may be a negative operational behavior of the AV 110 providing the ride service (“negative AV behavior”), i.e., an AV behavior that negatively influence the quality of the ride service, such as an AV behavior that can impact operational safety of the AV 110 or cause discomfort to the user 135. The defect detector 360 can identify negative AV behaviors from the AV behaviors associated with a ride service. The defect detector 360 may also identify merits in ride services, e.g., positive AV behaviors associated with ride services. A positive AV behavior is an AV behavior that improves the quality of the ride service, such as an AV behavior that can contribute to safe operation of the AV 110 or comfort of the user 135. A positive AV behavior may make the user 135 more willing to take another AV ride, versus a negative AV behavior may make the user 135 less willing to take another AV ride. The defect detector 360 may also identify neutral AV behaviors, i.e., AV behaviors that are not positive or negative.

The defect detector 360 may detect a negative, neutral, or positive AV behavior based on information from the AV behavior classifier 330, the user expression module 340, the environmental condition module, other modules or systems, or some combination thereof. The defect detector 360 may determine whether an AV behavior is negative, neutral, or positive based on one or more categories of the AV behavior determined by the AV behavior classifier 330, one or more user sentiments towards the AV behavior, one or more environmental conditions related to the AV behavior that are detected by the environmental condition module 350, or some combination thereof.

In some embodiments, the defect detector 360 determines that an AV behavior is negative, neutral, or positive based on a classification of the AV behavior by the AV behavior classifier 330. For instance, the defect detector 360 determines that an AV behavior in an undesirable behavior category is a defect, an AV behavior in a neutral behavior category is neutral, or an AV behavior in a desirable behavior category is a merit. In other embodiments, the defect detector 360 determines whether a classification of an AV behavior is valid considering other information, such as one or more user sentiments towards the AV behavior or one or more environmental conditions related to the AV behavior. For instance, the defect detector 360 determines whether an AV behavior classified into an undesirable behavior category by the AV behavior classifier 330 should be a negative behavior based on a user sentiment towards the AV behavior or an environmental condition related to the AV behavior.

In an example, the defect detector 360 determines that a harsh braking of the AV 110, even though classified as a undesirable behavior (e.g., typically undesired by the user 135), is not a negative behavior based on a detection of the environmental condition module 350 that a person suddenly ran into the street where the AV 110 was driving and the harsh braking was necessary to avoid hitting the person, or based on a detection of the user expression module 340 that the user 135 felt relieved or secure towards the harsh braking. As another example, the defect detector 360 determines that a honking of the AV 110 is not a negative behavior, despite that it is classified as a risky interaction by the AV behavior classifier 330, based on a detection of the environmental condition module 350 that a child was near the AV 110 at the time of the honking and the child was waving at the AV 110, or based on a detection of the user expression module 340 that the user 135 felt happy or loved towards the honking. Similarly, the defect detector 360 can determine whether an AV behavior classified into a positive or neutral behavior category by the AV behavior classifier 330 should be a negative behavior based on a user sentiment towards the AV behavior or an environmental condition related to the AV behavior.

In some embodiments, the defect detector 360 also determines severity of a negative behavior. The defect detector 360 may determine the severity based on an extent of the user's negative sentiment towards the negative behavior, i.e., the stronger the user's negative sentiment, the higher severity of the negative behavior. Additionally or alternatively, the defect detector 360 may compare one or more parameters of the negative behavior with corresponding parameters of a corresponding neural or positive behavior. Taking a hash brake that is determined to be a negative behavior for example, the defect detector 360 may determine the severity of the harsh brake based on a difference between a deacceleration rate of the AV 110 during the harsh brake and a deceleration rate of a standard or expected brake.

The scoring module 370 determines scores for ride services provided by AVs. In some embodiments, the scoring module 370 determines a score for a ride service (“ride score”), and the score indicates a level of satisfaction of the user 135 with the ride service. The score may also indicate whether or how much the user 135 is willing to request more ride services provided by AV 110. The scoring module 370 may determine the ride score based on all or a subset of AV behaviors detected by the defect detector 360 for the ride service. The subset of AV behaviors may be the negative AV behavior detected by the defect detector 360, the positive AV behavior detected by the defect detector 360, or both. In an embodiment, the scoring module 370 determines individual scores for each of the AV behaviors detected by the defect detector 360 and aggregates the individual scores to determine the ride score. The ride score may be a weighted sum or mean of the individual scores. The scoring module 370 can determine a weight for an AV behavior, e.g., based on an importance of the AV behavior to safety, an importance of the AV behavior to passenger comfort, an importance of the AV behavior to user satisfaction, and so on. In embodiments where the ride score is determined based on both negative and positive AV behaviors, the scoring module 370 may determine a negative individual score for a negative AV behavior and a positive individual score for a positive AV behavior. In embodiments where the defect detector 360 determines severity of a negative AV behavior, the scoring module 370 may determine the negative individual score for the negative AV behavior based on its severity.

In some embodiments, the scoring module 370 may compare the ride score with a threshold score. The threshold score may indicate a threshold level of satisfaction of the user 135 with the ride service, e.g., a threshold level of satisfaction that can trigger the user 135 to request ride services again. The threshold score may be different for different users 135. The scoring module 370 may determine a threshold score for a user 135 or a group of users 135. The users 135 in a same group may be users having similar attributes. In response to that the ride score is lower than a threshold score, the scoring module 370 may determine that the user 135 would be hesitant (or would not) to request another ride service and may generate a solution to improve that.

In some embodiments, the scoring module 370 may identify one or more negative AV behaviors as the main contributor to the low ride score. For instance, the scoring module 370 may identify one or more negative AV behaviors having individual scores lower than a threshold or lower than individual scores of one or more other negative AV behaviors. The identified negative AV behaviors may be considered as main reasons why the user 135 would be hesitant to request another ride service in the future. The scoring module 370 generate a report to address the identified negative AV behaviors. The report may include information explaining the cause of the identified negative AV behaviors, information specifying solutions to the identified negative AV behaviors, or other information. The scoring module 370 may provide the report to the user 135, e.g., through the client device 130, the client device interface 220, the onboard computer 150, etc. The report may help the user 135 to get more confidence in ride service provided by AVs 110.

The scoring module 370 may also develop a plan to address one or more negative AV behavior detected by the defect detector 360. In some embodiments, for each identified negative AV behavior, the scoring module 370 determine a root cause of the negative AV behavior. The root cause may be a failure in sensor detection, perception, planning, navigation, localization, and so on. In an example where there is a failure in sensor detection, the scoring module 370 may generate an instruction to maintain (e.g., to inspect, calibrate, repair, or replace) the sensor in the AV 110. The instruction may be provided to the vehicle manager 260 or to the AV 110 itself. In another example where there is a failure in perception, planning, navigation, or localization, the scoring module 370 may generate an instruction to update (e.g., re-train) a control model that controls the perception, planning, navigation, or localization of the AV 110 to improve the performance of the control model.

For an AV behavior that has been determined to be a negative behavior or has triggered a negative user sentiment, the scoring module 370 may facilitate a communication with the user to address the AV behavior. For instance, the scoring module 370 may generate a message that includes a compensation for the user's loss or negative sentiment (e.g., a refund or a discount for the ride service), a commitment to handle the AV behavior, other information that can help boost the user's satisfaction of the ride or the user's retention of AV ride, or some combination thereof. The scoring module 370 may send the message to a client device associated with the user or to the onboard computer 150 of the AV 110 during the user's ride in the AV 110 (e.g., immediately or shortly after the AV behavior is performed).

The prediction module 380 predict quality of future ride services. A future ride service may be a ride service that has been requested by a user 135 but not started or a ride service that has started by not finished. The prediction module 380 may retrieve data associated with a future ride service, such as AV data, user data, or environment data, and determine a ride score for the future ride service, e.g., using the same or similar method as how the scoring module 370 determines ride scores. The prediction module 380 may also compare the ride score of the future ride service with a threshold score, and in response to that the ride score is lower than the threshold score, the prediction module 380 may determine that the user 135 may not be satisfied with the ride service and may generate instructions to change the ride service, e.g., to change AV behaviors associated with the ride service.

In some embodiments, the prediction module 380 may identify one or more negative AV behaviors as the main contributor to the low ride score. The identified negative AV behaviors may be considered as main reasons why the user 135 would be unsatisfied with the ride service to be received by the user 135. For each identified negative AV behavior, the prediction module 380 may determine a root cause of the negative AV behavior and generate a solution to the root cause. The solution may be an instruction to the AV 110 to perform a different AV behavior in lieu of the negative AV behavior to improve the ride service. The prediction module 380 may determine the different AV behavior based on user interest, and the different AV behavior can be a positive AV behavior from the perspective of the user 135 receiving the ride service.

The prediction module 380 may determine an updated ride score for the ride service for which one or more different AV behaviors would be taken by the AV 110. The prediction module 380 may further compare the updated ride score with the threshold score, and in response to that the updated ride score is still lower than the threshold score, the prediction module 380 may continuously improve the ride service till the ride score is the same or greater than the threshold score.

Some or all functions of the ride evaluation module 230 may be performed by one or more models trained through machine learning technologies. For example, a model may be trained to receive data associated with ride services (e.g., AV operation records, user expressions, environmental data, etc.) and to output defects in ride services and classifications of the AV behaviors. As another example, a model may be trained to receive data associated with ride services and to output ride scores. As yet another example, a model may be trained to receive data associated with future ride services and to output predictions for future ride services.

Example Machine Learning System for Ride Evaluation

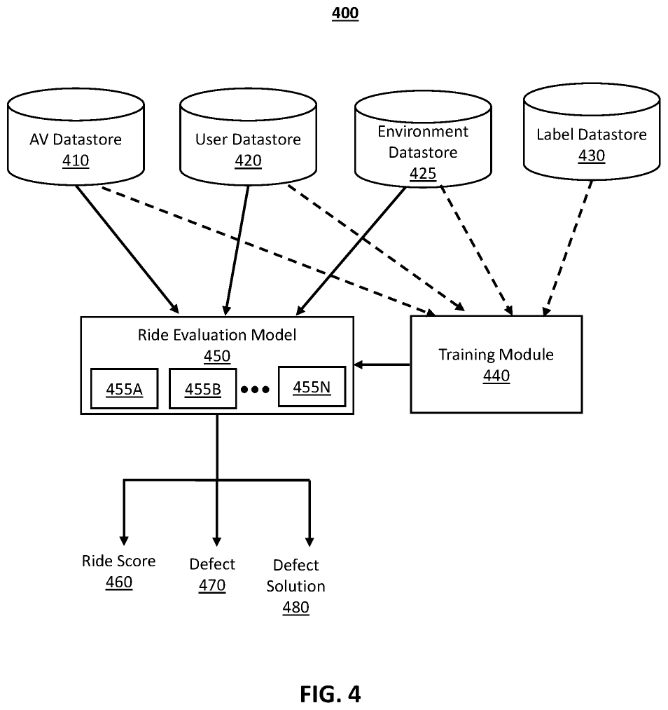

FIG. 4 illustrates a machine learning system 400 for ride evaluation, according to some embodiments of the present disclosure. The machine learning system 400 includes an AV datastore 410, a user datastore 420, an environment datastore 425, a label datastore 430, a training module 440, and a ride evaluation model 450. In alternative configurations, the machine learning system 400 may include different, fewer, or more components. Further, functionality attributed to one component of the machine learning system 400 may be accomplished by a different component included in the machine learning system 400, a different component included in the fleet management system 120, or a different system than those illustrated, such as the onboard computer 150. Also, different components or different functions of the same component of the machine learning system 400 may be implemented in different systems or devices, such as the fleet management system 120, the onboard computer 150, or other systems or devices.

The AV datastore 410 stores AV data associated with ride services. The AV data may include AV operation records, AV sensor data, and so on. The AV data may be from one or more AVs 110 providing ride services. The AV data may also include data from the vehicle manager 260.

The user datastore 420 stores user data associated with ride services. The user data includes user requests for ride services, user expression associated with ride services, and so on. The user data in the user datastore 420 may include data from client devices 130, client device interface 220, onboard computers of AVs 110, user datastore 240, and so on.

The environment datastore 425 stores environment data associated with ride services. The environment data includes sensor data capturing environments where AV 110 operates to provide ride services. The environment data may also include data from third-party systems that provide information of environments where AV 110 operates to provide ride services.

The label datastore 430 stores ground-truth labels for some AV data, user data, and environment data in the datastores 410, 420, and 425. The ground-truth labels indicate a ground-truth feature (e.g., a known feature) of corresponding AV data, user data, and environment data. An example ground-truth labels may be a ground-truth classification of an AV behavior, a ground-truth sentiment of a user 135 (e.g., a sentiment confirmed by the user 135 her/himself), a ground-truth ride score, and so on. The ground-truth labels may be generated by the training module 440 and can be used to train the ride evaluation model 450, e.g., through supervised machine learning.

The training module 440 trains the ride evaluation model 450. The training module 440 applies machine learning techniques to generate the ride evaluation model 450 that when applied to data associated with ride services outputs evaluations or predictions of ride services, such as determinations made by the ride evaluation module 230. As part of the generation of the ride evaluation model 450, the training module 440 may form a training set, e.g., by using data stored in the AV datastore 410, user datastore 420, environment datastore 425, and the label datastore 430. A training set includes training samples and ground-truth labels of the training samples. A training sample may include a set of data associated with a ride service. The training sample may have one or more ground-truth labels. In some embodiments, the training module 440 may identify a positive training set that have the property in question, e.g., satisfying ride services that trigger users 135 to request more ride services. The user satisfaction may be trip-level (e.g., user satisfaction on a particular trip), user level (e.g., user retention based on multiple trip), or a combination of both. The training module 440 may also form a negative training set of that lack the property in question, e.g., dissatisfying ride services that made users 135 hesitant to request more ride services

The training module 440 extracts feature values from the training set, the features being variables deemed potentially relevant to whether or not the ride services have the associated property or properties. An ordered list of the features for a ride service may be feature vector for the ride service. In one embodiment, the training module 440 applies dimensionality reduction (e.g., via linear discriminant analysis (LDA), principle component analysis (PCA), or the like) to reduce the amount of data in the feature vectors for ride services to a smaller, more representative set of data.

The training module 440 may use supervised machine learning to train the ride evaluation model 450, e.g., with the feature vectors of the positive training set and the negative training set serving as the inputs. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

In some embodiments, a validation set is formed of data associated with additional ride services, other than those in the training sets, which have already been determined to have or to lack the property in question. The training module 440 applies the trained ride evaluation model 450 to the ride services of the validation set to quantify the accuracy of the ride evaluation model 450. Common metrics applied in accuracy measurement include: Precision=TP/(TP+FP) and Recall=TP/(TP+FN), where precision is how many the ride evaluation model 450 correctly predicted (TP or true positives) out of the total it predicted (TP+FP or false positives), and recall is how many the ride evaluation model 450 correctly predicted (TP) out of the total number of ride services that did have the property in question (TP+FN or false negatives). The F score (F-score=2*PR/(P+R)) unifies precision and recall into a single measure. In one embodiment, the training module 440 iteratively re-trains the ride evaluation model 450 until the occurrence of a stopping condition, such as the accuracy measurement indication that the model is sufficiently accurate, or a number of training rounds having taken place.

In some embodiments, the training module 440 continuously trains a part of or the whole ride evaluation model 450. For instance, after the training module 440 trains the ride evaluation model 450, the ride evaluation model 450 receives data associated with a ride service and output a ride score for the ride service. The training module 440 may receive feedback on the ride service from the user 135 receiving the ride service. The feedback may be a rating on the ride service, a request for another ride service (which can indicate that the user 135 is satisfied with the ride service), an absence of request for any additional ride services (which can indicate that the user 135 is unsatisfied with the ride service), etc. The training module 440 can generate a ground-truth label based on the feedback from the user 135 and form a new training sample that includes the data associated with the ride service and the ground-truth label. The training module 440 uses the new training sample to further train the ride evaluation model 450. The training module 440 can continuously generate new training sets and re-train the ride evaluation model 450 as it receives more user feedbacks.

The ride evaluation model 450 is trained to generate various outputs based on data associated with ride services. The outputs may include some or all outputs of the ride evaluation module 230, such as defects in ride services, ride scores, predictions for future ride services, and so on. For purpose of illustration, FIG. 4 shows three outputs from the ride evaluation model 450: ride score 460, defect 470, and defect solution 480. The defect 470 may include information specifying one or more negative AV behaviors. The defect solution 480 may include information specifying how to correct the one or more negative AV behaviors in the defect 470. In other embodiments, there can be different, more, or fewer outputs from the ride evaluation model 450.

As shown in FIG. 4, the ride evaluation model 450 includes a plurality of components 455A-455N (collectively referred to as “components 455” or “component 455”). In other embodiments, the ride evaluation model 450 may include a different number of components. In some embodiments, each component 455 is a separate model, and the components 455 can be trained or applied separately. Different components 455 may be implemented in different systems or devices. In other embodiments, the ride evaluation model 450 is a single integrated model that can generate various outputs. In an example, the ride evaluation model 450 is a neutral network including a plurality of layers. Each component 455 may be a different layer of the neural network. Different outputs of the ride evaluation model 450 may be generated by different layers of the neutral network. For instance, the neutral network includes a layer outputting outputs classifications of AV behaviors, a layer outputting user sentiments towards ride services, a layer outputting environmental conditions related to ride services, a layer outputting defects in ride services, a layer outputting ride scores, a layer outputting predictions, and so on.

The ride evaluation model 450 can be partially or wholly customized for a user 135 or a group of users 135. For instance, a part of or the whole ride evaluation model 450 with may be trained with data associated with ride services provided to a cluster of users, and the ride evaluation model 450 may be used for evaluating other ride services provided to the cluster of users 135 or ride services provided to users 135 that are similar to the cluster of users 135. A user 135 may be considered similar to another user 135 or be grouped in the same cluster as another user 135 based on one or more similar interests (e.g., interests with respect to ride services, interests in walking, etc.), similar user profiles, similar use case (e.g., going to a grocery store to pick up groceries right in front of the store, etc.), and so on.

Example Sensor Suite

FIG. 5 is a block diagram showing the sensor suite 140, according to some embodiments of the present disclosure. The sensor suite 140 includes exterior sensors 510, a LIDAR sensor 520, a RADAR sensor 530, and interior sensors 540. The sensor suite 140 may include any number of the types of sensors shown in FIG. 5, e.g., one or more exterior sensors 510, one or more LIDAR sensors 520, etc. The sensor suite 140 may have more types of sensors than those shown in FIG. 5, such as the sensors described with respect to FIG. 1. In other embodiments, the sensor suite 140 may not include one or more of the sensors shown in FIG. 5.

The exterior sensors 510 detect objects in an environment around the AV 110. The environment may include a scene in which the AV 110 operates. Example objects include persons, buildings, traffic lights, traffic signs, vehicles, street signs, trees, plants, animals, or other types of objects that may be present in the environment around the AV 110. In some embodiments, the exterior sensors 510 include exterior cameras having different views, e.g., a front-facing camera, a back-facing camera, and side-facing cameras. One or more exterior sensors 510 may be implemented using a high-resolution imager with a fixed mounting and field of view. One or more exterior sensors 510 may have adjustable field of views and/or adjustable zooms. In some embodiments, the exterior sensors 510 may operate continually during operation of the AV 110. In an example embodiment, the exterior sensors 510 capture sensor data (e.g., images, etc.) of a scene in which the AV 110 drives. In other embodiment, the exterior sensors 510 may operate in accordance with an instruction from the onboard computer 150 or an external system, such as the ride evaluation module 230 of the fleet management system 120. Some of all of the exterior sensors 510 may capture sensor data of one or more objects in an environment surrounding the AV 110 based on the instruction.

The LIDAR sensor 520 measures distances to objects in the vicinity of the AV 110 using reflected laser light. The LIDAR sensor 520 may be a scanning LIDAR that provides a point cloud of the region scanned. The LIDAR sensor 520 may have a fixed field of view or a dynamically configurable field of view. The LIDAR sensor 520 may produce a point cloud that describes, among other things, distances to various objects in the environment of the AV 110.

The RADAR sensor 530 can measure ranges and speeds of objects in the vicinity of the AV 110 using reflected radio waves. The RADAR sensor 530 may be implemented using a scanning RADAR with a fixed field of view or a dynamically configurable field of view. The RADAR sensor 530 may include one or more articulating RADAR sensors, long-range RADAR sensors, short-range RADAR sensors, or some combination thereof.

The interior sensors 540 detect the interior of the AV 110, such as objects inside the AV 110. Example objects inside the AV 110 include users (e.g., passengers), client devices of users, components of the AV 110, items delivered by the AV 110, items facilitating services provided by the AV 110, and so on. The interior sensors 540 may include multiple interior cameras to capture different views, e.g., to capture views of an interior feature, or portions of an interior feature. The interior sensors 540 may be implemented with a fixed mounting and fixed field of view, or the interior sensors 540 may have adjustable field of views and/or adjustable zooms, e.g., to focus on one or more interior features of the AV 110. The interior sensors 540 may transmit sensor data to a perception module (such as the perception module 630 described below in conjunction with FIG. 6), which can use the sensor data to classify a feature and/or to determine a status of a feature.

In some embodiments, the interior sensors 540 include on or more input sensors that allow users 135 to provide input. For instance, a user 135 may use an input sensor to provide information indicating his/her sentiment towards a ride in the AV 110. The input sensors may include touch screen, microphone, keyboard, mouse, or other types of input devices. In an example, the interior sensors 540 includes a touch screen that is controlled by the onboard computer 150. The onboard computer 150 may present questionnaires on the touch screen and receive user answers to the questionnaires through the touch screen. A questionnaire may include one or more questions about a ride the user 135 is taking, have taken, or will take. The onboard computer 150 may receive the questions from the ride evaluation module 230, which created the questions for determining a sentiment of the user 135 towards the ride, a part of the ride, or a particular AV behavior associated with the ride.

In some embodiments, some or all of the interior sensors 540 may operate continually during operation of the AV 110. In other embodiment, some or all of the interior sensors 540 may operate in accordance with an instruction from the onboard computer 150 or an external system, such as the ride evaluation module 230 of the fleet management system 120. The interior sensors 540 may include a camera that can capture images of passengers. The interior sensors 540 may also include a thermal sensor (e.g., a thermocouple, an infrared sensor, etc.) that can capture a temperature (e.g., body temperature) of the passenger. The interior sensors 540 may further include one or more microphones that can capture sound in the AV 110, such as a conversation made by a passenger.

Example Onboard Computer

FIG. 6 is a block diagram showing the onboard computer 150 of the AV 110 according to some embodiments of the present disclosure. The onboard computer 150 includes an AV datastore 610, a sensor interface 620, a perception module 630, a control module 640, and a record module 650. In alternative configurations, fewer, different and/or additional components may be included in the onboard computer 150. For example, components and modules for conducting route planning, controlling movements of the AV 110, and other vehicle functions are not shown in FIG. 6. Further, functionality attributed to one component of the onboard computer 150 may be accomplished by a different component included in the onboard computer 150 or a different system, such as the fleet management system 120.

The AV datastore 610 stores data associated with operations of the AV 110. The AV datastore 610 may store one or more operation records of the AV 110. An operation record is a record of an operation of the AV 110, e.g., an operation for providing a ride service. The operation record may include information indicating operational behaviors of the AV during the operation. The operations record may also include data used, received, or captured by the AV during the operation, such as map data, instructions from the fleet management system 120, sensor data captured by the AV 110, and so on. In some embodiments, the AV datastore 610 stores a detailed map that includes a current environment of the AV 110. The AV datastore 610 may store data in the map datastore 250. In some embodiments, the AV datastore 610 stores a subset of the map datastore 250, e.g., map data for a city or region in which the AV 110 is located.

The sensor interface 620 interfaces with the sensors in the sensor suite 140. The sensor interface 620 may request data from the sensor suite 140, e.g., by requesting that a sensor capture data in a particular direction or at a particular time. For example, in response to a request for sensor data from the ride evaluation module 230, the sensor interface 620 instructs the sensor suite 140 to capture sensor data of an environment surrounding the AV 110. In some embodiments, the request from the ride evaluation module 230 may specify which sensor(s) in the sensor suite 140 to provide the sensor data, and the sensor interface 620 may request the sensor(s) to capture data. The request may further provide one or more settings of a sensor, such as orientation, resolution, accuracy, focal length, and so on. The sensor interface 620 can request the sensor to capture data in accordance with the one or more settings.

A request for sensor data from the ride evaluation module 230 may be a request for real-time sensor data, and the sensor interface 620 can instruct the sensor suite 140 to immediately capture the sensor data and to immediately send the sensor data to the sensor interface 620. The sensor interface 620 is configured to receive data captured by sensors of the sensor suite 140, including data from exterior sensors mounted to the outside of the AV 110, and data from interior sensors mounted in the passenger compartment of the AV 110. The sensor interface 620 may have subcomponents for interfacing with individual sensors or groups of sensors of the sensor suite 140, such as a camera interface, a LIDAR interface, a RADAR interface, a microphone interface, etc. In embodiments where the sensor interface 620 receives a request for sensor data from the ride evaluation module 230, the sensor interface 620 may provide sensor data received from the sensor suite 140 to the ride evaluation module 230.

The perception module 630 identifies objects and/or other features captured by the sensors of the AV 110. For example, the perception module 630 identifies objects in the environment of the AV 110 and captured by one or more exterior sensors (e.g., the sensors 210-230). The perception module 630 may include one or more classifiers trained using machine learning to identify particular objects. For example, a multi-class classifier may be used to classify each object in the environment of the AV 110 as one of a set of potential objects, e.g., a vehicle, a pedestrian, or a cyclist. As another example, a pedestrian classifier recognizes pedestrians in the environment of the AV 110, a vehicle classifier recognizes vehicles in the environment of the AV 110, etc. The perception module 630 may identify travel speeds of identified objects based on data from the RADAR sensor 530, e.g., speeds at which other vehicles, pedestrians, or birds are traveling. As another example, the perception module 63-may identify distances to identified objects based on data (e.g., a captured point cloud) from the LIDAR sensor 520, e.g., a distance to a particular vehicle, building, or other feature identified by the perception module 630. The perception module 630 may also identify other features or characteristics of objects in the environment of the AV 110 based on image data or other sensor data, e.g., colors (e.g., the colors of Christmas lights), sizes (e.g., heights of people or buildings in the environment), makes and models of vehicles, pictures and/or words on billboards, etc.

The perception module 630 may further process data from captured by interior sensors (e.g., the interior sensors 540 of FIG. 5) to determine information about and/or behaviors of passengers in the AV 110. For example, the perception module 630 may perform facial recognition based on sensor data from the interior sensors 540 to determine which user is seated in which position in the AV 110. As another example, the perception module 630 may process the sensor data to determine passengers' states, such as gestures, activities (e.g., whether passengers are engaged in conversation), moods (whether passengers are bored (e.g., having a blank stare, or looking at their phones)), and so on. The perception module may analyze data from the interior sensors 540, e.g., to determine whether passengers are talking, what passengers are talking about, the mood of the conversation (e.g., cheerful, annoyed, etc.). In some embodiments, the perception module 630 may determine individualized moods, attitudes, or behaviors for the users, e.g., if one user is dominating the conversation while another user is relatively quiet or bored; if one user is cheerful while the other user is getting annoyed; etc. In some embodiments, the perception module 630 may perform voice recognition, e.g., to determine a response to a game prompt spoken by a user.

In some embodiments, the perception module 630 fuses data from one or more interior sensors 540 with data from exterior sensors (e.g., exterior sensors 510) and/or AV datastore 610 to identify environmental objects that one or more users are looking at. The perception module 630 determines, based on an image of a user, a direction in which the user is looking, e.g., a vector extending from the user and out of the AV 110 in a particular direction. The perception module 630 compares this vector to data describing features in the environment of the AV 110, including the features' relative location to the AV 110 (e.g., based on real-time data from exterior sensors and/or the AV's real-time location) to identify a feature in the environment that the user is looking at.

While a single perception module 630 is shown in FIG. 6, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 640 controls operations of the AV 110, e.g., based on information from the sensor interface 620 or the perception module 630. In some embodiments, the control module 640 controls operation of the AV 110 by using a trained model, such as a trained neutral network. The control module 640 may provide input data to the control model, and the control model outputs operation parameters for the AV 110. The input data may include sensor data from the sensor interface 620 (which may indicate a current state of the AV 110), objects identified by the perception module 630, or both. The operation parameters are parameters indicating operation to be performed by the AV 110. The operation of the AV 110 may include perception, prediction, planning, localization, motion, navigation, other types of operation, or some combination thereof. The control module 640 may provide instructions to various components of the AV 110 based on the output of the control model, and these components of the AV 110 will operation in accordance with the instructions. In an example where the output of the control model indicates that a change of traveling speed of the AV 110 is required given a prediction of traffic condition, the control module 640 may instruct the motor of the AV 110 to change the traveling speed of the AV 110. In another example where the output of the control model indicates a need to detect characteristics of an object in the environment around the AV 110 (e.g., detect a speed limit), the control module 640 may instruct the sensor suite 140 to capture an image of the speed limit sign with sufficient resolution to read the speed limit and instruct the perception module 630 to identify the speed limit in the image.

The record module 650 generates operation records of the AV 110 and stores the operations records in the AV datastore 610. The record module 650 may generate an operation record in accordance with an instruction from the fleet management system 120, e.g., the ride evaluation module 230 or vehicle manager 260. The instruction may specify data to be included in the operation record. The record module 650 may determine one or more time stamps for an operation record. In an example of an operation record for a ride service, the record module 650 may generate time stamps indicating the time when the ride service starts, the time when the ride service ends, times of specific AV behaviors associated with the ride service, and so on. The record module 650 can transmit operation record to the fleet management system 120, e.g., the ride evaluation module 230.

Example Method of Rating Trip Provided by AV

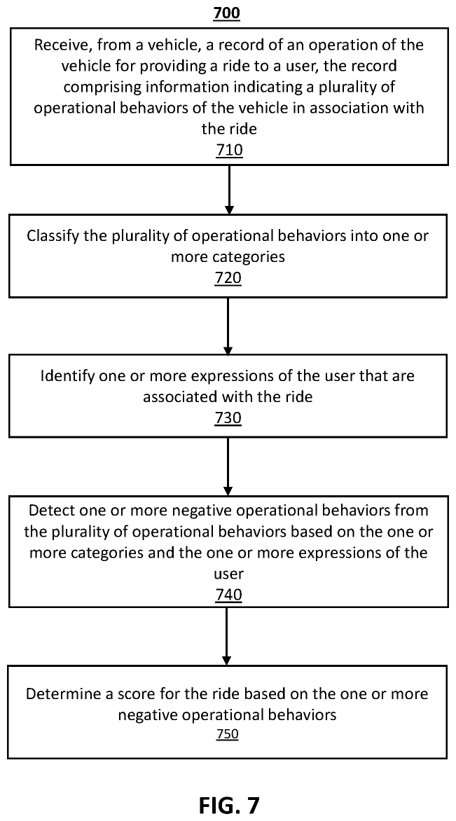

FIG. 7 is a flowchart showing a method 700 of evaluating a ride provided by a vehicle, according to some embodiments of the present disclosure. The method 700 may be performed by the ride evaluation module 230. Although the method 700 is described with reference to the flowchart illustrated in FIG. 7, many other methods of evaluating a ride provided by a vehicle may alternatively be used. For example, the order of execution of the steps in FIG. 7 may be changed. As another example, some of the steps may be changed, eliminated, or combined.

The ride evaluation module 230 receives, in 710, a record of an operation of the vehicle for providing a ride to a user. The record comprises information indicating a plurality of operational behaviors of the vehicle in association with the ride. The vehicle may be an AV 110.

The ride evaluation module 230 clarifies, in 720, the plurality of operational behaviors into one or more categories. The one or more categories may include a desirable behavior category, an undesirable behavior category, or a neutral behavior category. In some embodiments, the ride evaluation module 230 identifies an operational behavior of the vehicle and selects one or more categories of the operational behavior from a plurality of predetermined categories, e.g., based on a location, time, or description of the operational behavior.

The ride evaluation module 230 identifies, in 740, one or more expressions of the user that are associated with the ride. In some embodiments, the ride evaluation module 230 receives information provided by the user through a client device associated with the user or an onboard device of the vehicle. The ride evaluation module 230 can use the received information to determine a sentiment of the user associated with the ride, e.g., a sentiment of the user towards one or more operational behaviors of the vehicle. In alternative embodiments, the ride evaluation module 230 determines a sentiment of the user during the ride based on sensor data captured by a sensor in the vehicle.

The ride evaluation module 230 detects, in 740, one or more negative operational behaviors from the plurality of operational behaviors based on the one or more categories and the one or more expressions of the user. In some embodiments, the ride evaluation module 230 may detect the one or more negative operational behaviors further based on sensor data captured by one or more sensors of the vehicle during the operation of the vehicle. The sensor data may indicate one or more conditions in an environment in which the vehicle operated for providing the ride.

In some embodiments, the ride evaluation module 230 may determine whether an operational behavior of the plurality of operational behaviors is classified into a category of objectively undesirable behaviors. In an embodiment, after determining that the operational behavior is classified into the category of objectively undesirable behaviors, the ride evaluation module 230 may determine that the operational behavior is a negative operational behavior. In another embodiment, after determining that the operational behavior is classified into the category of undesirable behaviors, the ride evaluation module 230 may determine a sentiment of the user towards the operational behavior. After determining the sentiment of the user is positive, the ride evaluation module 230 may determine that the operational behavior is not a negative operational behavior. In yet another example, after determining that the operational behavior is classified into the category of undesirable behaviors, the ride evaluation module 230 may detect a condition in an environment surrounding the vehicle at a time of the operational behavior based on sensor data captured by an exterior sensor of the vehicle and determine, based on the condition in the environment, that the operational behavior is not a negative operational behavior.

The ride evaluation module 230 determines, in 750, a score for the ride based on the one or more negative operational behaviors. In some embodiments, the one or more negative operational behaviors comprises a plurality of negative operational behaviors. The ride evaluation module 230 may determine the score for the ride comprises by determining an individual score for each respective operational behavior of the plurality of negative operational behaviors and aggregating individual scores of the plurality of negative operational behaviors. The ride evaluation module 230 may determine a respective weight for each respective operational behavior of the plurality of negative operational behaviors based on a category into which the respective operational behavior is classified. The ride evaluation module 230 may further aggregate the individual scores based on respective weights of the plurality of negative operational behaviors.

Select Examples

Example 1 provides a method, including: receiving, from a vehicle, a record of an operation of the vehicle for providing a ride to a user, the record including information indicating a plurality of operational behaviors of the vehicle in association with the ride; classifying the plurality of operational behaviors into one or more categories; identifying one or more expressions of the user that are associated with the ride; detecting one or more negative operational behaviors from the plurality of operational behaviors based on the one or more categories and the one or more expressions of the user; and determining a score for the ride based on the one or more negative operational behaviors. The score indicates the user's satisfaction of the ride.

Example 2 provides the method of example 1, where detecting the one or more negative operational behaviors includes: detecting the one or more negative operational behaviors further based on sensor data captured by one or more sensors of the vehicle during the operation of the vehicle, where the sensor data indicates a condition in an environment in which the vehicle operated for providing the ride.

Example 3 provides the method of example 1, where identifying the one or more expressions of the user includes: receiving information provided by the user through a client device associated with the user or an onboard device of the vehicle; and determining a sentiment of the user associated with the ride based on the information.

Example 4 provides the method of example 1, where identifying the one or more expressions of the user includes: determining a sentiment of the user associated with the ride based on sensor data captured by a sensor in the vehicle.

Example 5 provides the method of example 1, where detecting the one or more negative operational behaviors from the plurality of operational behaviors includes: determining whether an operational behavior of the plurality of operational behaviors is classified into a category of undesirable behaviors.

Example 6 provides the method of example 5, where detecting the one or more negative operational behaviors from the plurality of operational behaviors further includes: after determining that the operational behavior is classified into the category of undesirable behaviors, determining that the operational behavior is a negative operational behavior.

Example 7 provides the method of example 5, where detecting the one or more negative operational behaviors from the plurality of operational behaviors further includes: after determining that the operational behavior is classified into the category of undesirable behaviors, determining whether the operational behavior is a negative operational behavior based on a sentiment of the user towards the operational behavior.

Example 8 provides the method of example 5, where detecting the one or more negative operational behaviors from the plurality of operational behaviors further includes: after determining that the operational behavior is classified into the category of undesirable behaviors, detecting a condition in an environment surrounding the vehicle at a time of the operational behavior based on sensor data captured by an exterior sensor of the vehicle; and determining, based on the condition in the environment, that the operational behavior is not a negative operational behavior.

Example 9 provides the method of example 1, where the one or more negative operational behaviors includes a plurality of negative operational behaviors, and determining the score for the ride includes: determining an individual score for each respective operational behavior of the plurality of negative operational behaviors; and aggregating individual scores of the plurality of negative operational behaviors.

Example 10 provides the method of example 9, where aggregating the individual scores of the plurality of negative operational behaviors includes: determining a respective weight for each respective operational behavior of the plurality of negative operational behaviors based on a category into which the respective operational behavior is classified; and aggregating the individual scores based on respective weights of the plurality of negative operational behaviors.

Example 11 provides one or more non-transitory computer-readable media storing instructions executable to perform operations, the operations including: receiving, from a vehicle, a record of an operation of the vehicle for providing a ride to a user, the record including information indicating a plurality of operational behaviors of the vehicle in association with the ride; classifying the plurality of operational behaviors into one or more categories; identifying one or more expressions of the user that are associated with the ride; detecting one or more negative operational behaviors from the plurality of operational behaviors based on the one or more categories and the one or more expressions of the user; and determining a score for the ride based on the one or more negative operational behaviors. The score indicates the user's satisfaction of the ride.

Example 12 provides the one or more non-transitory computer-readable media of example 11, where detecting the one or more negative operational behaviors includes: detecting the one or more negative operational behaviors further based on sensor data captured by one or more sensors of the vehicle during the operation of the vehicle, where the sensor data indicates a condition in an environment in which the vehicle operated for providing the ride.

Example 13 provides the one or more non-transitory computer-readable media of example 12, where identifying the one or more expressions of the user includes: receiving information provided by the user through a client device associated with the user or an onboard device of the vehicle; and determining a sentiment of the user associated with the ride based on the information.

Example 14 provides the one or more non-transitory computer-readable media of example 11, where identifying the one or more expressions of the user includes: determining a sentiment of the user associated with the ride based on sensor data captured by a sensor in the vehicle.

Example 15 provides the one or more non-transitory computer-readable media of example 11, where detecting the one or more negative operational behaviors from the plurality of operational behaviors includes: determining whether an operational behavior of the plurality of operational behaviors is classified into a category of undesirable behaviors.

Example 16 provides the one or more non-transitory computer-readable media of example 15, where detecting the one or more negative operational behaviors from the plurality of operational behaviors further includes: after determining that the operational behavior is classified into the category of undesirable behaviors, determining whether the operational behavior is a negative operational behavior based on a sentiment of the user towards the operational behavior.

Example 17 provides the one or more non-transitory computer-readable media of example 15, where detecting the one or more negative operational behaviors from the plurality of operational behaviors further includes: after determining that the operational behavior is classified into the category of undesirable behaviors, detecting a condition in an environment surrounding the vehicle at a time of the operational behavior based on sensor data captured by an exterior sensor of the vehicle; and determining, based on the condition in the environment, that the operational behavior is not a negative operational behavior.

Example 18 provides a computer system, including: a computer processor for executing computer program instructions; and one or more non-transitory computer-readable media storing computer program instructions executable by the computer processor to perform operations including: receiving, from a vehicle, a record of an operation of the vehicle for providing a ride to a user, the record including information indicating a plurality of operational behaviors of the vehicle in association with the ride, classifying the plurality of operational behaviors into one or more categories, identifying one or more expressions of the user that are associated with the ride, detecting one or more negative operational behaviors from the plurality of operational behaviors based on the one or more categories and the one or more expressions of the user, and determining a score for the ride based on the one or more negative operational behaviors. The score indicates the user's satisfaction of the ride.

Example 19 provides the computer system of example 18, where detecting the one or more negative operational behaviors includes: detecting the one or more negative operational behaviors further based on sensor data captured by one or more sensors of the vehicle during the operation of the vehicle, where the sensor data indicates a condition in an environment in which the vehicle operated for providing the ride.

Example 20 provides the computer system of example 18, where identifying the one or more expressions of the user includes: receiving information provided by the user through a client device associated with the user or an onboard device of the vehicle; and determining a sentiment of the user associated with the ride based on the information.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
receiving, from a vehicle, a record of an operation of the vehicle for providing a ride to a user, the record comprising information indicating a plurality of operational behaviors of the vehicle in association with the ride;
classifying the plurality of operational behaviors into one or more categories;
identifying one or more expressions of the user that are associated with the ride;
detecting one or more negative operational behaviors from the plurality of operational behaviors based on the one or more categories and the one or more expressions of the user; and
determining a score for the ride based on the one or more negative operational behaviors, the score indicating the user's satisfaction of the ride.

2. The method of claim 1, wherein detecting the one or more negative operational behaviors comprises:
detecting the one or more negative operational behaviors further based on sensor data captured by one or more sensors of the vehicle during the operation of the vehicle,
wherein the sensor data indicates a condition in an environment in which the vehicle operated for providing the ride.

3. The method of claim 1, wherein identifying the one or more expressions of the user comprises:
receiving information provided by the user through a client device associated with the user or an onboard device of the vehicle; and
determining a sentiment of the user associated with the ride based on the information.

4. The method of claim 1, wherein identifying the one or more expressions of the user comprises:
determining a sentiment of the user associated with the ride based on sensor data captured by a sensor in the vehicle.

5. The method of claim 1, wherein detecting the one or more negative operational behaviors from the plurality of operational behaviors comprises:
determining whether an operational behavior of the plurality of operational behaviors is classified into a category of undesirable behaviors.

6. The method of claim 5, wherein detecting the one or more negative operational behaviors from the plurality of operational behaviors further comprises:
after determining that the operational behavior is classified into the category of undesirable behaviors, determining that the operational behavior is a negative operational behavior.

7. The method of claim 5, wherein detecting the one or more negative operational behaviors from the plurality of operational behaviors further comprises:
after determining that the operational behavior is classified into the category of undesirable behaviors, determining whether the operational behavior is a negative operational behavior based on a sentiment of the user towards the operational behavior.

8. The method of claim 5, wherein detecting the one or more negative operational behaviors from the plurality of operational behaviors further comprises:
after determining that the operational behavior is classified into the category of undesirable behaviors, detecting a condition in an environment surrounding the vehicle at a time of the operational behavior based on sensor data captured by an exterior sensor of the vehicle; and
determining, based on the condition in the environment, that the operational behavior is not a negative operational behavior.

9. The method of claim 1, wherein the one or more negative operational behaviors comprises a plurality of negative operational behaviors, and determining the score for the ride comprises:
determining an individual score for each respective operational behavior of the plurality of negative operational behaviors; and
aggregating individual scores of the plurality of negative operational behaviors.

10. The method of claim 9, wherein aggregating the individual scores of the plurality of negative operational behaviors comprises:
determining a respective weight for each respective operational behavior of the plurality of negative operational behaviors based on a category into which the respective operational behavior is classified; and
aggregating the individual scores based on respective weights of the plurality of negative operational behaviors.

11. One or more non-transitory computer-readable media storing instructions executable to perform operations, the operations comprising:
receiving, from a vehicle, a record of an operation of the vehicle for providing a ride to a user, the record comprising information indicating a plurality of operational behaviors of the vehicle in association with the ride;
classifying the plurality of operational behaviors into one or more categories;
identifying one or more expressions of the user that are associated with the ride;
detecting one or more negative operational behaviors from the plurality of operational behaviors based on the one or more categories and the one or more expressions of the user; and
determining a score for the ride based on the one or more negative operational behaviors, the score indicating the user's satisfaction of the ride.

12. The one or more non-transitory computer-readable media of claim 11, wherein detecting the one or more negative operational behaviors comprises:
detecting the one or more negative operational behaviors further based on sensor data captured by one or more sensors of the vehicle during the operation of the vehicle,
wherein the sensor data indicates a condition in an environment in which the vehicle operated for providing the ride.

13. The one or more non-transitory computer-readable media of claim 12, wherein identifying the one or more expressions of the user comprises:
receiving information provided by the user through a client device associated with the user or an onboard device of the vehicle; and
determining a sentiment of the user associated with the ride based on the information.

14. The one or more non-transitory computer-readable media of claim 11, wherein identifying the one or more expressions of the user comprises:
determining a sentiment of the user associated with the ride based on sensor data captured by a sensor in the vehicle.

15. The one or more non-transitory computer-readable media of claim 11, wherein detecting the one or more negative operational behaviors from the plurality of operational behaviors comprises:
determining whether an operational behavior of the plurality of operational behaviors is classified into a category of undesirable behaviors.

16. The one or more non-transitory computer-readable media of claim 15, wherein detecting the one or more negative operational behaviors from the plurality of operational behaviors further comprises:
after determining that the operational behavior is classified into the category of undesirable behaviors, determining whether the operational behavior is a negative operational behavior based on a sentiment of the user towards the operational behavior.

17. The one or more non-transitory computer-readable media of claim 15, wherein detecting the one or more negative operational behaviors from the plurality of operational behaviors further comprises:
after determining that the operational behavior is classified into the category of undesirable behaviors, detecting a condition in an environment surrounding the vehicle at a time of the operational behavior based on sensor data captured by an exterior sensor of the vehicle; and
determining, based on the condition in the environment, that the operational behavior is not a negative operational behavior.

18. A computer system, comprising:
a computer processor for executing computer program instructions; and
one or more non-transitory computer-readable media storing computer program instructions executable by the computer processor to perform operations comprising:
receiving, from a vehicle, a record of an operation of the vehicle for providing a ride to a user, the record comprising information indicating a plurality of operational behaviors of the vehicle in association with the ride,
classifying the plurality of operational behaviors into one or more categories,
identifying one or more expressions of the user that are associated with the ride,
detecting one or more negative operational behaviors from the plurality of operational behaviors based on the one or more categories and the one or more expressions of the user, and
determining a score for the ride based on the one or more negative operational behaviors, the score indicating the user's satisfaction of the ride.

19. The computer system of claim 18, wherein detecting the one or more negative operational behaviors comprises:
detecting the one or more negative operational behaviors further based on sensor data captured by one or more sensors of the vehicle during the operation of the vehicle,
wherein the sensor data indicates a condition in an environment in which the vehicle operated for providing the ride.

20. The computer system of claim 18, wherein identifying the one or more expressions of the user comprises:
receiving information provided by the user through a client device associated with the user or an onboard device of the vehicle; and
determining a sentiment of the user associated with the ride based on the information.
